(19) United States
(12) Patent Application Publication
(10) Pub. No.: US 2005/0095041 A1
(43) Pub. Date: May 5, 2005

(54) Device to prevent breakaway of transfer belt and transfer unit including same

(75) Inventors: Hong-iI Kim, Gumi-si (KR); Moon-bae Park, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/950,602

(22) Filed: Sep. 28, 2004

(30) Foreign Application Priority Data
Oct. 30, 2003 (KR) 2003-76278

(51) Int. Cl. G03G 15/01

(52) U.S. Cl. 399/302

(57) ABSTRACT

A device to prevent breakaway of a transfer belt and a transfer unit equipped with the same. A device to prevent breakaway includes rib members each provided along opposite longitudinal edges of the inner surface of the transfer belt, and guide members each provided at one of opposite ends of a roller of the transfer unit, in order to guide the rib members. Each of the guide members is provided with a guide projection that is in contact with one of the rib members.

### CROSS-REFERENCE TO RELATED APPLICATIONS

This application claims the benefit of Korean Patent Application No. 2003-76278 filed Oct. 30, 2003, in the Korean Intellectual Property Office, the disclosure of which is incorporated herein by reference.

### BACKGROUND OF THE INVENTION

1. Field of the Invention

The present invention relates to a device to prevent breakaway of a transfer belt and a transfer unit equipped with the same. In particular, the present invention relates to a device to prevent breakaway of a transfer belt, in which guide members that are in contact with the transfer belt with rib members include guide projections, thereby preventing the transfer belt from breaking away from an endless track, and a transfer unit equipped with the same.

2. Description of the Related Art

In general, an image forming apparatus such as a printer or a copying machine is provided with a transfer unit that receives a developed image and transfers it onto a paper. However, such a transfer unit frequently causes a malfunction of the image forming apparatus when a transfer belt installed in the transfer unit and moving on an endless track breaks away from the endless track.

Specifically, such a transfer belt is supported by a plurality of rollers and sometimes the respective stubs of the plurality of rollers are not capable of remaining balanced with each other when the transfer belt is driven on the plurality of rollers. As a result, the transfer belt is driven to be biased to a side by the plurality of rollers, and the biased transfer belt may break away from the rollers since excessive forces act on the transfer belt at the opposite longitudinal edges thereof. In other words, breakaway moments cause the breakaway of the transfer belt from the enduring stresses on the endless transfer belt due to the forces acting on the opposite longitudinal edges of the transfer belt.

Therefore, the breakaway of a transfer belt from an endless track caused when the transfer belt moves on the endless track is a serious problem in a transfer unit, and much research is being made to solve such a problem.

### SUMMARY OF THE INVENTION

Additional aspects and/or advantages of the invention will be set forth in part in the description which follows and, in part, will be obvious from the description, or may be learned by practice of the invention.

Accordingly, it is an aspect of the present invention to solve the above-mentioned problems occurring in the related art.

It is another aspect of the present invention to provide a device that is capable of preventing breakaway of a transfer belt from a track thereof and a transfer unit equipped with the same.

The foregoing and/or other aspects are achieved by providing a device to prevent breakaway of a transfer belt including: a plurality of rib members provided on opposite longitudinal edges of an inner surface of the transfer belt, and a plurality of guide members provided at opposite ends of one of the rollers, in order to guide the rib members, each of the guide members including a guide projection in contact with one of the rib members, thereby preventing breakaway of the transfer belt from the rollers.

Each of the guide members includes a cylindrical guide body, including a first side in contact with an end of the respective roller and a second side having a guide projection formed along a peripheral edge of the guide body and projected away from the guide body.

The second side of the guide body further includes a stub member at a center thereof, and the guide projection inclines toward the stub member and the respective roller. The guide projection and the guide body are formed of a single piece. In this case, the guide member is idled rather than being driven by the roller.

The foregoing and/or other aspects are also achieved by providing a transfer unit to transfer an image from an organic photoconductive medium of an image forming apparatus to a recording medium, including a transfer belt in contact with the organic photoconductive medium; a plurality of rollers provided inside of the transfer belt to support the transfer belt; a plurality of rib members respectively provided on opposite longitudinal edges of an inner surface of the transfer belt; and a plurality of guide members respectively provided on opposite ends of one of the plurality of rollers, in order to guide the rib members, each of the guide members comprising a guide projection in contact with one of the rib members, thereby preventing breakaway of the transfer belt from the rollers.

Each of the guide members includes a cylindrical guide body, including a first side in contact with an end of the respective roller and a second side i including a guide projection formed along a peripheral edge of the guide body and projected away from the guide body.

The second side of each guide body includes a stub member at a center thereof, and the guide projection inclines toward the stub member and the respective roller. The guide projection and the guide body include a single piece. In this case, the guide member is idled rather than being driven by the at least one roller.

In addition, the guide member is not driven by the respective roller, and an outer diameter of each of the guide members is greater than or equal to an outer diameter of the respective roller, thereby increasing a tension of the transfer belt.

Furthermore, longitudinal opposite edges of inner and outer surfaces of the transfer belt include reinforcement members to protect the transfer belt when the transfer belt comes into contact with the rollers, and the sum of the outer diameter of the guide member and the thickness of the reinforcement members coming into contact with the rollers is equal to or larger than the outer diameter of the at least one roller, thereby increasing the tension of the transfer belt.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view illustrating an image forming device including a device for preventing breakaway of a transfer belt according to an embodiment of the present invention;

FIG. 2 is a cross-sectional view of main parts of a transfer belt and a roller of the image forming apparatus shown in FIG. 1; and

FIGS. 3A to 3C show various embodiments of the transfer belt and the roller shown in FIG. 2.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

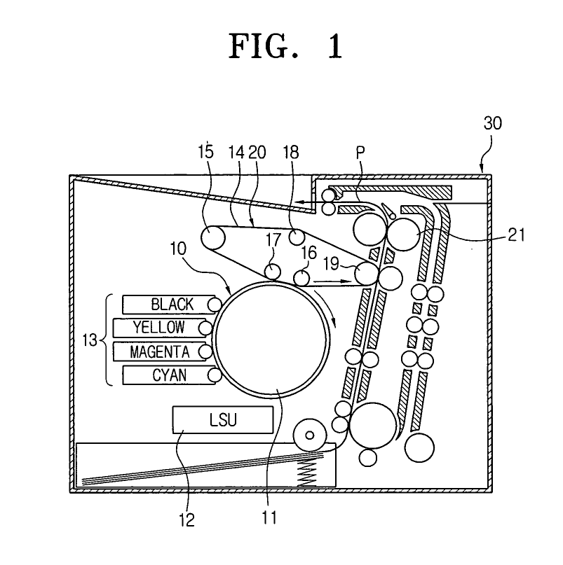

FIG. 1 is a schematic view an image forming apparatus including a transfer unit equipped with a transfer belt according to a first embodiment of the present invention. The reference symbol P indicates a paper feeding route.

As shown in the drawing, an image forming apparatus 30 generally includes an organic photoconductive unit 10 having an organic photoconductive medium 11 such as an OPC drum; a laser scanning unit (LSU) 12; a developing device 13; a transfer unit 20 including a transfer belt 14 in the form of an endless track; a plurality of rollers to circulate the transfer belt 14; and a fixation roller 21 to fix an image. In addition, the plurality of rollers includes a transfer roller 16 to transfer the image onto the transfer belt 14, a driving roller 19 to provide a driving force to the transfer belt 14 to transfer the image onto a recording medium such as paper, a tension roller to control the tension of the transfer belt 14, a nip roller 17, and a backup supporting roller 15 to idle as the driving roller 19 rotates. The elements cooperate with each other to sequentially perform a series of image forming processes such as electrification, exposure, development, transfer, fixation, etc., thereby forming a desired image on a paper.

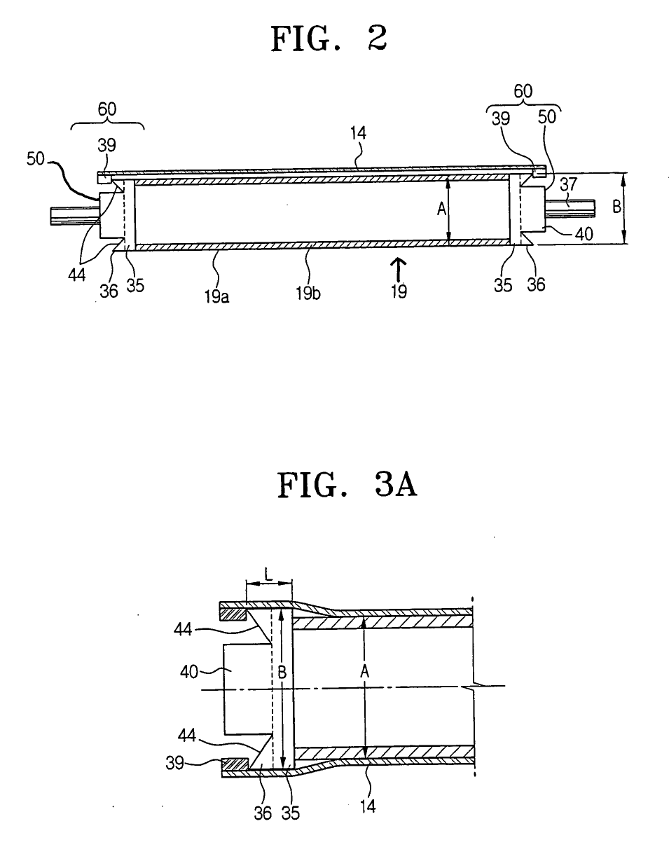

FIG. 2 is a cross-sectional view of a portion of a transfer belt and a roller of the image forming apparatus shown in FIG. 1.

The transfer unit 20 includes a transfer belt 14, a plurality of rollers 16, 17 and 18 provided inside of the transfer belt 14, and a pair of breakaway preventing devices 60.

The transfer belt 14 comes into contact with the organic photoconductive medium 11 of the image forming apparatus 30 and transfers an image onto a recording medium such as a paper, and the plurality of rollers 15, 16, 17, 18 and 19 support the transfer belt 14.

The driving roller 19 that is in contact with the transfer belt 14 includes a body 19a and a frictional part 19b surrounding the body 19a. The frictional part 19b has a predetermined friction coefficient and a predetermined surface roughness and frictionally drives the transfer belt 14 in one direction. In addition, the frictional part 19b is grinded in the direction opposite to the rotational direction of the driving roller 19, thereby preventing slippage of the transfer belt 14 at the time of driving. The driving roller 19 also includes a shaft 37.

Each of the breakaway prevention devices 60 includes a rib member 39 and a guide member 50.

Each rib member 39 is provided along a longitudinal edge of the inner surface of the transfer belt 14, and is attached to the transfer belt 14 by adhesive applied to the portion where the rib member 39 and the transfer belt 14 are in contact.

The guide members 50 are provided at opposite ends of at least one of the plurality of rollers 15, 16, 17, 18 and 19 (driving roller 19 is illustrated herein) to guide the rib members 39, thereby preventing the transfer belt 14 from breaking away from the rollers 15, 16, 17, 18 and 19. Each guide member 50 includes a cylindrical guide body 35, a guide projection 36 and a stub member 40 having inclined surfaces 44.

Hereinbelow, the state in which the transfer belt 14 is in close contact with the driving roller 19 and moves on the endless track is described. However, the present embodiment is also applicable to the rollers 15, 16, 17 and 18.

Each guide body 35 is in contact with one end of the driving roller 19 at one side thereof and is formed with the guide projection 36 formed along the edge of the other side of the guide body 35 to project away from the guide body 35. The guide projections 36 contact the rib members 39, thereby preventing the transfer belt 14 from breaking away from the endless track. In addition, the other side of each guide body 35 is provided with a stub member 40 at the center thereof, and the guide projection 36 inclines toward the stub member 40 and the guide body 35. The guide projection 36 may be formed in unison with the guide member 50 or may be separately formed and then anchored to the guide member 50 by way of an anchoring unit (such as bolts or the like).

In order for the transfer belt 14 to be only frictionally driven by the frictional part 19 of the driving roller 19, the guide members 50 are idled rather than being driven by the driving roller 19.

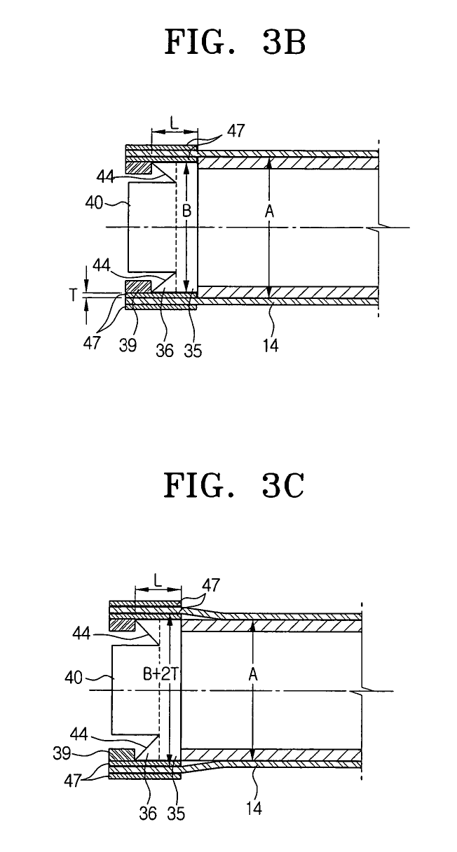

It is noted that FIG. 2 illustrates that the outer diameter A of the driving roller 19 is equal to the outer diameter B of the guide members 50, while FIG. 3A shows the case in which the outer diameter A of the driving roller 19 is smaller than the outer diameter B of the guide members 50.

As shown in FIGS. 2 and 3A, if the outer diameter B is greater than or equal to the outer diameter A, the rib members 39 partially contact the inclined surfaces 44 so that the contact area between the rib member 39 and the inclined surfaces 44 is reduced, and a larger tension acts on contact portions L of the transfer belt 14 with the guide members 50 because of the concentration of force on the rib members 39. Because sufficient tension is on the transfer belt 14, breakaway of the transfer belt 14 is prevented.

FIGS. 3B and 3C illustrate a second embodiment of the present invention, in which reinforcement members 47 are additionally provided on the outer and inner surfaces of the transfer belt 14 along the opposite longitudinal edges thereof.

The reinforcement members 47 protect the transfer belt 14 when the transfer belt 14 comes into contact with the driving roller 19. The reinforcement members 47 are formed of a tape and protect the transfer belt 14 when an excessive tension is induced in the transfer belt 14. The reinforcement members 47 also prevent the transfer belt 14 from being worn or subjected to fatigue due to continuous contact with the driving roller 19. In addition, the reinforcement members 47 have a predetermined thickness T.

As can be seen from FIGS. 3B and 3C, the sum of the outer diameter B of the guide members 50 and the thickness of the reinforcement members 47 that come into contact with the guide members 50, i.e., 2×T, will be equal to or greater than the outer diameter B of the driving roller 19.

Similar to the case shown in FIGS. 2 and 3A, the rib members 39 partially contact the inclined surfaces 44 of the guide member 50 and therefore, the contact area between the rib members 39 and the inclined surfaces 44 is reduced. Accordingly, force is concentrated on the rib members 39, and great tension acts on the contact portions L of the transfer belt 14 which are in contact with the guide member 50. Because sufficient tension acts on the transfer belt 14, breakaway of the transfer belt 14 can be avoided.

Hereinbelow, the operation of the device for preventing breakaway of the transfer belt 14 according to the embodiments of the present invention and a transfer unit including the same will be described with reference to FIGS. 2, 3A, 3B and 3C.

First, a driving force is applied to the driving roller 19 and then the transfer belt 14 is driven. At this time, if the plurality of rollers 15, 16, 17, 18 and 19 are not balanced with each other, the transfer belt 14 is driven to bias a particular side of the rollers.

The guide projections 36 are provided along the edges of the guide bodies 35 of the guide members 50 in such a manner that the guide projections 36 are projected and incline toward the guide body 35 and the stub member 40. Therefore, if the transfer belt 14 is driven to bias to a particular side on an endless track, and thus an excessive force may be exerted on the rib members 39 of the transfer belt 14.

However, because the rib members 39 partially contact the inclined surfaces 44 of the respective guide member 50, the contact area between the rib members 39 and the inclined surfaces 44 is reduced. Furthermore, due to the concentration of force on the rib members 39, a great amount of tension acts on the contact portions L between the respective guide member 50 and the transfer belt 14. As a result, due to a sufficient tension on the transfer belt 14, breakaway of the transfer belt 14 from the endless track can be avoided.

In other words, if the outer diameter B of the guide member 50 or the sum of the outer diameter B of the guide member 50 and the thickness 2×T of the reinforcement members 47, i.e., B+2T is greater than or equal to the outer diameter A of the rollers 15, 16, 17, 18 and 19, a sufficient tension is generated on the contact parts of the transfer belt 14, whereby it is possible to prevent the breakaway of the transfer belt 14.

Therefore, even if the tension applied to the transfer belt 14 varies while the transfer belt 14 is being driven or the axes of the rollers 15, 16, 17, 18 and 19 are not parallel to each other, whereby the transfer belt would break away, the guide members 50 and the rib members 39 can provide a sufficient neutralizing action against such phenomena, whereby it is possible to prevent the breakaway of the transfer belt.

As described above, according to the embodiments of the present invention, even if a tension induced in a transfer belt varies while the transfer belt is being driven or axes of a plurality of rollers for supporting and/or driving the transfer belt are not parallel to each other, whereby the transfer belt would break away, guide members provided on at least one of the plurality of rollers and rib members provided on the transfer belt can cooperate with each other, thereby providing a sufficient neutralizing action against such phenomena, to prevent the breakaway of the transfer belt.

In addition, due to such a neutralizing action, it is possible to reduce the requirement that a plurality of rollers, a transfer belt and a transfer unit equipped with these components must be machined and assembled to a very precise size, whereby machining and assembling processes can be simplified and thus manufacturing costs can be reduced so that the competitiveness in price can be enhanced.

Although a few embodiments of the present invention have been shown and described, it would be appreciated by those skilled in the art that changes may be made in these embodiments without departing from the principles and spirit of the invention, the scope of which is defined in the claims and their equivalents.

1. A device to prevent breakaway of a transfer belt of an image forming apparatus comprising the transfer belt to transfer an image onto a recording medium, an organic photoconductive medium in contact with the transfer belt, and a plurality of rollers within the transfer belt, the device comprising:
a plurality of rib members provided on opposite longitudinal edges of an inner surface of the transfer belt; and
a plurality of guide members provided at opposite ends of one of the rollers, in order to guide the rib members,
each of the guide members comprising a guide projection in contact with one of the rib members, thereby preventing breakaway of the transfer belt from the rollers.

2. The device according to claim 1, wherein each of the guide members comprises a cylindrical guide body, including a first side in contact with an end of the respective roller and a second side having a guide projection formed along a peripheral edge of the guide body and projected away from the guide body.

3. The device according to claim 2, wherein the second side of the guide body further comprises a stub member at a center thereof, and the guide projection inclines toward the stub member and the respective roller.

4. The device according to claim 2, wherein the guide projection and the guide body comprise a single piece.

5. The device according to claim 2, wherein the guide member is not driven by the respective roller.

6. A transfer unit to transfer an image from an organic photoconductive medium of an image forming apparatus to a recording medium, comprising:
a transfer belt in contact with the organic photoconductive medium;
a plurality of rollers inside of the transfer belt to support the transfer belt;
a plurality of rib members respectively provided on opposite longitudinal edges of an inner surface of the transfer belt; and
a plurality of guide members respectively provided on opposite ends one of the plurality of rollers, in order to guide the rib members,
each of the guide members comprising a guide projection in contact with one of the rib members, thereby preventing breakaway of the transfer belt from the rollers.

7. The transfer unit according to claim 6, wherein each of the guide members comprises a cylindrical guide body, comprising a first side in contact with an end of the respective roller and a second side comprising a guide projection formed along a peripheral edge of the guide body and projected away from the guide body.

8. The transfer unit according to claim 7, wherein the second side of each guide body comprises a stub member at a center thereof, and the guide projection inclines toward the stub member and the respective roller.

9. The transfer unit according to claim 8, wherein the guide member and the guide body comprise a single piece.

10. The transfer unit according to claim 7, wherein the guide member is not driven by the respective roller.

11. The transfer unit according to claim 6, wherein an outer diameter of each of the guide members is greater than or equal to an outer diameter of the respective roller, thereby increasing a tension of the transfer belt.

12. The transfer unit according to claim 6, wherein longitudinal opposite edges of inner and outer surfaces of the transfer belt comprise reinforcement members to protect the transfer belt when the transfer belt comes into contact with the rollers.

13. The transfer unit according to claim 12, wherein one of the plurality of rollers is a drive roller to drive the transfer belt.

14. The transfer unit according to claim 13, wherein a sum of an outer diameter of the guide members and a thickness of the reinforcement members in contact with the guide members is greater than or equal to an outer diameter of the drive roller.

15. An apparatus to receive an image and transfer the image to a recording medium, comprising:
a transfer belt comprising first and second guides; and
a first roller to support the transfer belt, comprising first and second ribs respectively in contact with the first and second guides.

16. The apparatus according to claim 15, wherein the first roller drives the transfer belt.

17. The apparatus according to claim 15, wherein the first roller is driven by the transfer belt.

18. The apparatus according to claim 16, further comprising a second roller driven by the transfer belt.

19. The apparatus according to claim 17, further comprising a second roller to drive the transfer belt.

20. An apparatus to receive an image and transfer the image to a recording medium, comprising:
a transfer belt to receive the image;
a plurality of rollers to support the transfer belt; and
a guide member to neutralize a bias of the transfer belt towards a side of the rollers.

21. The apparatus according to claim 20, wherein the bias is due to a variation in a tension applied to the transfer belt, or axes of the rollers not being parallel.

22. An image forming apparatus comprising:
a photoconductive medium to form an image; and
an apparatus to receive the formed image and transfer the received image to a recording medium, comprising:
a transfer belt comprising first and second guides, and
a first roller to support the transfer belt, comprising first and second ribs respectively in contact with the first and second guides.
